(19) United States
(12) Patent Application Publication
(10) Pub. No.: US 2009/0262880 A1
(43) Pub. Date: Oct. 22, 2009

(54) MAN MADE PLATINUM GROUP METAL AS PALLADIUM

(76) Inventor: Kuai-Teng Hsu, Clarksville, MD (US)

Correspondence Address: Kuai-Teng Hsu, 7371 Hallmark Road, Clarksville, MD, 21029, US

(21) Appl. No.: 12/082,830

(22) Filed: Apr. 16, 2008

(51) Int. Cl. G21B 1/00

(52) U.S. Cl. 376/108

(57) ABSTRACT

A man made method, utilizing particles bombardment technique, is used to produce Palladium. The particles bombardment technique uses particle accelerator to accelerate Beryllium particles to high speed. These high speed Beryllium particles contain high energy. These high energy Beryllium particles are used to bombard Molybdenum elements. Then elements Beryllium and Molybdenum undergo cold fusion process that they are combined to produce Palladium.

### BACKGROUND OF PRESENT INVENTION

1. Field of Invention

The present invention relates to a method, and more particularly a man made method, to produce Platinum Group Metal as Palladium.

2. Description of Related Arts

### Platinum Group Metals (PGMs)

Platinum Group Metals (PGMs) consists of fivemetals as: Palladium ,Rhodium ,Ruthenium ,Iridium and Osmium.

### ISOTOPE

Elements with the same atomic number, but different atomic mass are called isotope.

### PALLADIUM

### HISTORY

Palladium was discovered by a British chemist W. H. Wollaston in 1803. It was named after the asteroid “Pallas” which was discovered at about the same time and from the Greek name “Pallas”, goddess of wisdom. The techniques used by Wollaston in the separation of PGM are considered to be the basis for modern PGM metallurgy.

### PROPERTIES

Palladium is a very rare precious metal. In nature it is generally found as part of the so-called Platinum Group Metals (PGMs). The PGMs are classified under one heading due to their similar chemical and physical properties and because they are often found together. PGMs are also called the noble metals as a result of their superior ability to withstand oxidation and corrosion.

Palladium is a scarce and costly metal and, as the other PGMs, it shows unusual properties. The specific chemical and physical properties of this metal are of essential use for a number of different industrial applications. Palladium is widely used in “green” applications, particularly in catalysts for the automobile industry. However, its market is very tiny and prices are extremely volatile.

Palladium is the least dense and lowest melting of the Platinum Group Metals. It is a silver-white metal and does not tarnish in air. When annealed, it is soft and ductile. Cold working greatly increases its strength and hardness. It resists high temperature corrosion and oxidation but it is attacked by nitric and sulfuric acid. Palladium has been named the “amazing soaking sponge” because at room temperature it has the unusual property of absorbing up to 900 times its own volume of hydrogen. Hydrogen readily diffuses through heated palladium and this provides a means of purifying the gas. Finely divided it is a good catalyst and is used for hydrogenation and dehydrogenation reactions.

The importance of palladium, based on its catalytic properties, increased considerably since the 1970s when demand for autocatalysts grew, thanks to the introduction of automotive emission standards in the developed countries.

However, during the nineties, use of palladium in autocatalyst soared, since it replaced more expensive and less efficient platinum and emission standards tightened all over the world. Due to the remarkable increase in palladium prices in the late nineties and 2000, preference for palladium in autocatalysts is being reversed.

One of the most important obstacles for a more widespread use of palladium has been its limited supply. At present time, production of palladium is concentrated in a few areas in the world, mainly in the Russian Federation and South Africa. This concentration of production fills the market with uncertainties concerning prices and availability of supply.

### QUALITY

Palladium is considered as a native metal even though it is never 100% pure palladium. It normally occurs alloyed with platinum ores and other elements of the platinum group in placer deposits. Palladium occurs in volcanic rocks, such as peridotite or norite. It is also found associated with nickel-copper deposits. Palladium abundance in the Earth's crust is about 0.015 parts per million.

The quality marks for palladium may be used on articles composed of at least 95 per cent palladium or 90 per cent palladium and 5 per cent platinum, iridium, ruthenium, rhodium, osmium or gold. However, standard palladium purity is 99.95%.

Palladium forms useful alloys with many metals. When added to small amounts of gold, the yellow color fades and alloys containing 15 per cent palladium are quite white.

Gold-palladium alloys, with or without other elements, are used in jewelry as “white gold”. An alloy which contains 95 parts of palladium, 2 to 4 part of ruthenium and the remainder of rhodium, looks like platinum but is only half as heavy.

### PRODUCTION

The production of PGMs requires very complex processing techniques that were not available until the end of the 19th century. Moreover, the high melting points of PGMs were an additional obstacle to work with them. It was only with the development of new refining techniques that these metals were more widely used for new industrial applications.

Research and technology in the platinum group metals sector is mainly focused on developing and producing new functional materials for high-tech advanced products in the electronics, chemicals and automotive industries.

The South African institution Mintek is the main body involved in the development of new technologies for PGMs industry. Mintek plays an important role in developing both extraction and new applications technologies for PGMs.

### ISOTOPES

Naturally-occurring palladium is stable and has atomic mass 106. It has many isotopes. One of them has atomic mass 105 and is stable also. This palladium isotope of mass 105 has 22% mole fraction of palladium isotopic composition.

### PARTICLE ACCELERATOR

A particle accelerator is a device that uses electric fields to propel electrically charged particles to high speed. These high speed particles contain high energy.

### PARTICLE BOMBARDMENT TECHNIQUE

Particles accelerated by particle accelerator to high energy can be used to bombard target elements for conducting experiments .This is called particle bombardment technique.

### NUCLEAR FUSION

Nuclear fusion is the process by which multiple nuclei join together to form a heavier nucleus. It is accompanied by the release or absorption of energy depending on the masses of the nuclei involved.

### COLD FUSION

Cold fusion is a nuclear fusion process that occurs at normal temperature.

### SUMMARY OF THE PRESENT INVENTION

The main object of the present invention is to provide a man made method to produce Palladium, which is one of the Platinum Group Metals.

Another object of the present invention is to man made Palladium by using particle bombardment technique.

Another object of the present invention is to man made Palladium by utilizing particle accelerator to accelerate Beryllium particles to high speed. These high speed Beryllium particles contain high energy. Then let these high energy Beryllium particles to bombard Molybdenum element. Then elements Beryllium and Molybdenum undergo cold fusion process that they are combined to produce Palladium.

### BRIEF DESCRIPTION OF THE DRAWING

None

### DETAILED DESCRIPTION OF THE PREFERRED EMBODIMENT

It was proved by experiment and reported in publication that, by utilizing particle bombardment technique, we can use particle accelerator to accelerate the particles of element Chromium (atomic symbol Cr) to high speed. These high speed Chromium particles contain high energy. Then let these high energy Chromium particles to bombard the element Bismuth (atomic symbol Bi). Then elements Chromium and Bismuth undergo cold fusion process that they are combined to produce the element Bohrium (atomic symbol Bh) and one neutron (atomic symbol n).

In equation, it is described as

Cr+Bi→Bh+n (1)

The total atomic number on both sides of equation (1) are balanced as
atomic number on the left side of equation (1)

| element | atomic number |
|---|---|
| Cr | 24 |
| Bi | 83 |

Total atomic number on left side is 107

atomic number on right side of equation (1)

| element | atomic number |
|---|---|
| Bh | 107 |
| Neutron | 0 |

Total atomic number on right side is 107

So, both sides of the equation (1) have total atomic number 107.

Also, total atomic mass on both sides of equation (1) are balanced as:
atomic mass on left side of equation (1)

| element | atomic mass |
|---|---|
| Cr | 54 |
| Bi | 209 |

Total atomic mass on left side is 263

atomic mass on right side of equation (1)

| element | atomic mass |
|---|---|
| Bh | 262 |
| Neutron | 1 |

Total atomic mass on right side is 263

So, both sides of equation (1) have atomic mass 263.

Using the same theory and technique, we can use particle accelerator to accelerate the particle of element Beryllium (atomic symbol Be) to high speed. These high speed Beryllium particles contain high energy. Then let these high energy Beryllium particles to bombard the element Molybdenum (atomic symbol Mo). Then elements Beryllium and Molybdenum undergo cold fusion process that they are combined to produce Palladium (atomic symbol Pd). This Palladium produced has atomic mass 105 and is an isotope of naturally-occurring Palladium. This Palladium isotope of mass 105 is stable and has 22% mole fraction of Palladium isotopic composition.

In equation, it is described as

Be+Mo→Pd (2)

The total atomic number on both sides of equation (2) are balanced as:
atomic number on the left side of equation (2)

| element | atomic number |
|---|---|
| Be | 4 |
| Mo | 42 |

Total atomic number on left side is 46

atomic number on right side of equation (2)

| element | atomic number |
|---|---|
| Pd | 46 |

Total atomic number on right side is 46

So, both sides of equation (2) have atomic number 46.

Also, the atomic mass on both sides of equation (2) are balanced as:
atomic mass on left side of equation (2)

| element | atomic mass |
|---|---|
| Be | 9 |
| Mo | 96 |

Total atomic mass on left side is 105

atomic mass on right side of equation (2)

| element | atomic mass |
|---|---|
| Pd | 105 |

Total atomic mass on right side is 105

So, both sides of the equation (2) have atomic mass 105.

This proves the equation (2) is valid.

What is claimed is:

1-5. (canceled)

6. A man made method to produce Palladium by cold fusion process between Beryllium and Molybdenum elements, comprising the following steps:
a. This method uses element particle bombardment technique.
b. This bombardment technique uses particle accelerator.
c. Beryllium particles are accelerated by particle accelerator to high speed.
d. These high speed Beryllium particles contain high energy.
e. These high energy Beryllium particles are used to bombard target Molybdenum elements.
f. Then, elements Beryllium and Molybdenum undergo cold fusion process that they are combined to produce Palladium.
